(19) United States
(12) Patent Application Publication
(10) Pub. No.: US 2020/0129366 A1
(43) Pub. Date: Apr. 30, 2020

(54) WALKER CAPABLE OF DETERMINING USE INTENT AND A METHOD OF OPERATING THE SAME

(71) Applicant: Wistron Corporation, New Taipei City (TW)

(72) Inventors: Yi-Hsi Huang, New Taipei City (TW); Shiou Hui Yang, New Taipei City (TW)

(21) Appl. No.: 16/231,847

(22) Filed: Dec. 24, 2018

(30) Foreign Application Priority Data
Oct. 29, 2018 (TW) 107138128

(51) Int. Cl. A61H 3/00; G06N 7/00; G06N 3/08; G06N 20/00

(52) U.S. Cl. CPC A61H 3/00; G06N 7/005; A61H 2201/1635; G06N 20/00; A61H 2201/5071; G06N 3/08

(57) ABSTRACT

A handle of a walker capable of determining use intent includes at least one movable member; fixed members slidingly coupled to the at least one movable member respectively; and pressure sensors disposed at joints between the fixed members and the at least one movable member respectively.

### CROSS-REFERENCE TO RELATED APPLICATIONS

This application claims priority to Taiwan Patent Application No. 107138128, filed on Oct. 29, 2018, the entire contents of which are herein expressly incorporated by reference.

### BACKGROUND OF THE INVENTION

### 1. Field of the Invention

The present disclosure generally relates to a walker, and more particularly to a handle of a walker capable of determining use intent and a method of operating the walker.

### 2. Description of Related Art

Mobility disability is an issue to be dealt with for the elderly and lower limb disabled people, and a variety of walking assist devices or walkers have been proposed to improve or solve the issue. The walking assist devices may be classified into active devices and passive devices. The active walking assist device mainly uses a motor to move the walking, but a user of the passive walking assist device provides motive force instead.

One primary function of the walking assist device is to predict intent on user's moving direction, which is used later to control the walking assist device. Glenn Wasson et al. discloses “User Intent in a Shared Control Framework for Pedestrian Mobility Aids,” published in Proceedings 2003 IEEE RSJ International Conference on Intelligent Robots and Systems (IROS 2003), which uses two 6-degrees of freedom (DOF) moment sensors respectively disposed in two handles to determine user's movement intent.

Glenn Wasson et al. disclose “A Physics-Based Model for Predicting User Intent in Shared-Control Pedestrian Mobility Aids,” published in 2004 IEEE RSJ International Conference on Intelligent Robots and Systems (IROS), which uses two 6-DOF moment sensors respectively disposed in two handles to measure moment, according to which user's movement intent may be determined.

Matthew Spenko et al. disclose “Robotic Personal Aids for Mobility and Monitoring for the Elderly,” published in IEEE TRANSACTIONS ON NEURAL SYSTEMS AND REHABILITATION ENGINEERING, volume 14, No. 3, September 2006, which uses six-axis torque sensors to measure torque applied on the handles.

Aaron Morris et al. disclose “A Robotic Walker That Provides Guidance,” published in 2003 IEEE International Conference on Robotics and Automation, September 2003, which uses force-sensing resistors, readings of which are transformed into translational and rotational velocities.

Hsiang-Pin Yang discloses “On the Design of a Robot Walking Helper Based on Human Intention,” a master thesis submitted to National Chiao Tung University, which uses force sensors, readings of which are used to deduce relationship between use intent and rotational torque.

The conventional walking assist devices primarily use multi-axis force sensors to determine user's intent on moving directions. The hardware structure design, application software development and sensing system integration of the walking assist devices have been currently being developed.

### SUMMARY OF THE INVENTION

One embodiment of the present disclosure provides a walker capable of determining use intent, a handle of which may include pressure sensors, particularly single-axis force sensors, disposed at joints between fixed members and movable members. Intent on moving direction may be determined according to sense values of the pressure sensors collected at the joints. Compared to conventional walkers that use multi-axis force sensors, the embodiment uses single-axis force sensors as the sensors of the handle of the walker to simplify system architecture.

Another embodiment of the present disclosure provides a method of operating a walker capable of determining use intent. Sense values corresponding to invent on moving direction are collected and machine-learning modeling is performed thereon, thereby obtaining a machine-learning model. According to a further embodiment of the present disclosure, intent on moving direction may be predicted based on the machine-learning model. The embodiments mentioned above use machine-learning technique to process the sense values in order to prevent complicated programming.

### BRIEF DESCRIPTION OF THE DRAWINGS

FIG. 1A shows a top-view scale drawing of a handle of a walker according to one embodiment of the present disclosure;

FIG. 1B shows a cross-sectional view scale drawing along a section line of FIG. 1A;

FIG. 1C shows a partial exploded-view scale drawing of the handle of FIG. 1A;

FIG. 1D shows a perspective-view scale drawing of the walker adopting the handle;

FIG. 1E shows a cross-sectional view scale drawing along a section line of FIG. 1A according to another embodiment of the present disclosure;

FIG. 1F shows a top-view scale drawing of the second stopper;

FIG. 1G shows a table illustrating the sense values of the sensor 1 to the sensor 12 with a variety of intent toward various directions;

FIG. 2 shows a flow diagram illustrating a method of determining intent on moving direction according to one embodiment of the present disclosure;

FIG. 3 shows a block diagram illustrating a system of determining intent on moving direction according to one embodiment of the present disclosure;

FIG. 4 shows a detailed flow diagram of step 22 of FIG. 2;

FIG. 5A schematically shows architecture of processing sense values to perform machine learning by using logistic modeling algorithm;

FIG. 5B shows one logistic unit of FIG. 5A; and

FIG. 6 shows a detailed flow diagram of step 24 of FIG. 2.

### DETAILED DESCRIPTION OF THE INVENTION

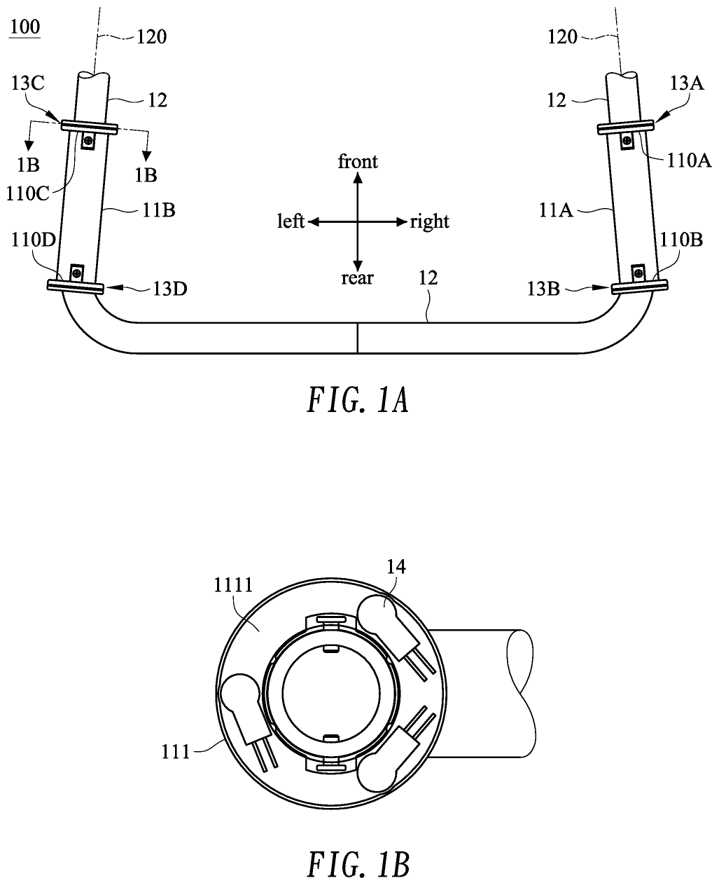

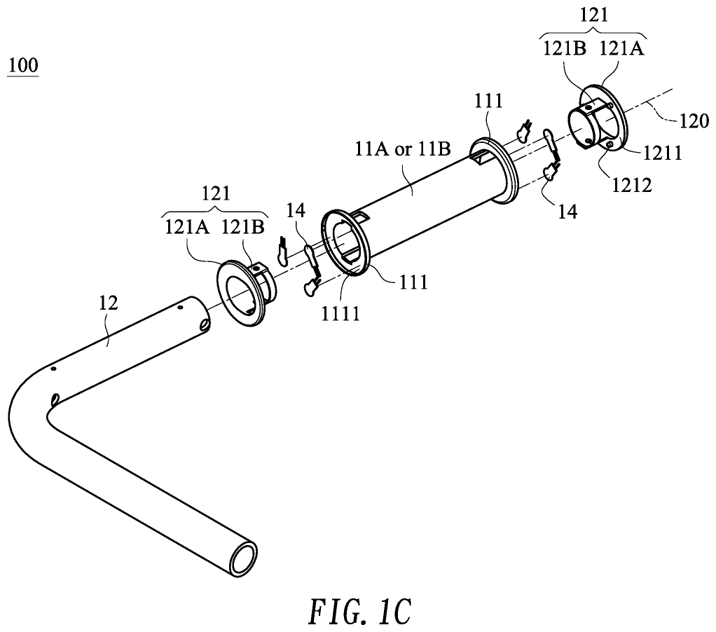

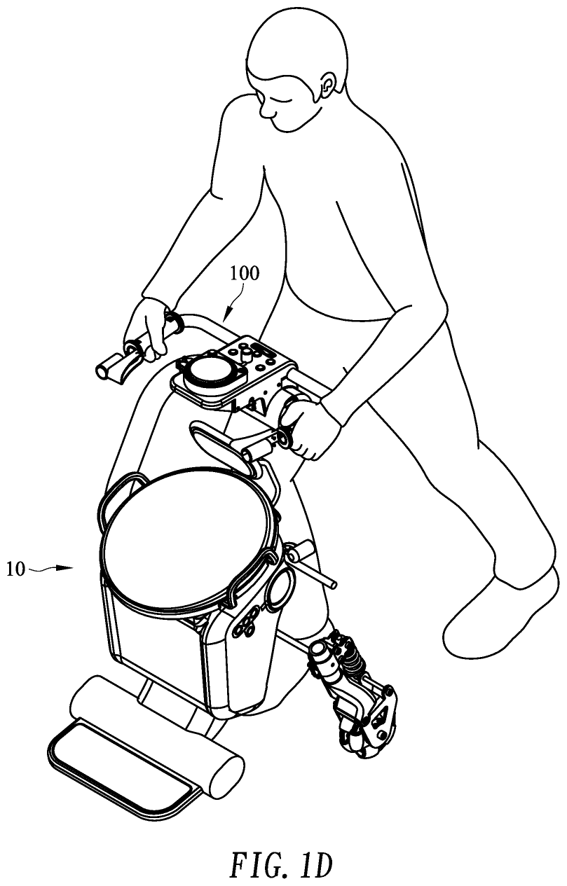

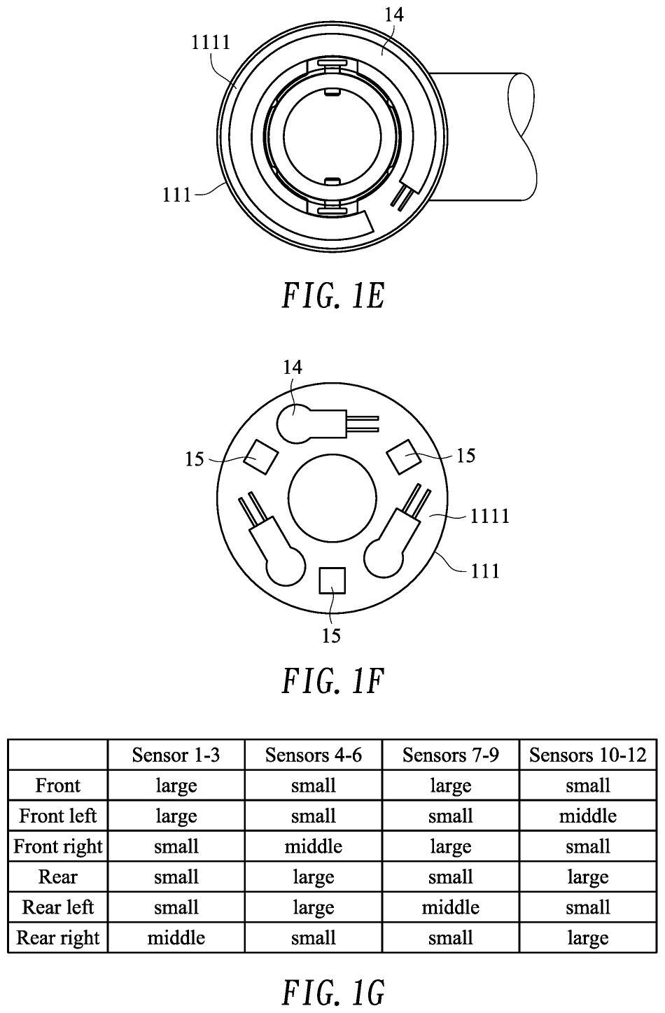

FIG. 1A shows a top-view scale drawing of a handle 100 of a walker 10 according to one embodiment of the present disclosure, FIG. 1B shows a cross-sectional view scale drawing along a section line 1B-1B′ of FIG. 1A, FIG. 1C shows a partial exploded-view scale drawing of the handle 100 of FIG. 1A, and FIG. 1D shows a perspective-view scale drawing of the walker 10 adopting the handle 100. The walker 10 of the embodiment may be an active walker or a passive walker.

In the embodiment, the handle 100 may include a first movable member 11A and a second movable member 11B to be held by a right hand and a left hand, respectively. The handle 100 may also include a plurality of fixed members 12 slidingly coupled to the first movable member 11A and the second movable member 11B respectively. Accordingly, the first movable member 11A and the second movable member 11B may slide between the fixed members 12, and may make reciprocating movements along a center axis of the fixed member 12. In the embodiment, the first movable member 11A, the second movable member 11B and the fixed members 12 may be, but not limited to, hollow tubes taking into consideration the structural strength and the weight.

As shown in FIG. 1A, two ends 110A and 110B of the first movable member 11A are slidingly coupled to the fixed members 12 at a first joint 13A and a second joint 13B, respectively. As exemplified in FIG. 1A, the first joint 13A is located at front right, and the second joint 13B is located at rear right. Similarly, two ends 110C and 110D of the second movable member 11B are slidingly coupled to the fixed members 12 at a third joint 13C and a fourth joint 13D, respectively. As exemplified in FIG. 1A, the third joint 13C is located at front left, and the fourth joint 13D is located at rear left.

In the embodiment, the fixed members 12 may have first stoppers 121 disposed on surfaces thereof at the joints 13A and 13B where the first movable member 12A and the fixed members 12 are coupled to each other, and at the joints 13C and 13D where the second movable member 12B and the fixed members 12 are coupled to each other. The first stopper 121 may include a ring flange 121A extended from the surface of the fixed member 12 and being perpendicular to the center axis 120 of the fixed member 12. The first stopper 121 may also include a fixing plate 121B connected to the flange 121A for fixing the flange 121A to the fixed member 12. The first movable member 11A and the second movable member 11B may have flange-shaped second stoppers 111 facing the corresponding second stoppers 121, disposed on and extended from surfaces thereof at the joints 13A and 13B where the first movable member 12A and the fixed members 12 are coupled to each other, and at the joints 13C and 13D where the second movable member 12B and the fixed members 12 are coupled to each other.

The handle 100 of the embodiment may include a plurality of sensors 14 such as pressure sensors, particularly single-axis force sensors, respectively disposed at the joints 13A and 13B where the first movable member 12A and the fixed members 12 are coupled to each other, and at the joints 13C and 13D where the second movable member 12B and the fixed members 12 are coupled to each other. At least one sensor 14 may be disposed at each joint 13A, 13B, 13C or 13D. In one embodiment, three sensors 14 may be disposed at each joint 13A, 13B, 13C or 13D taking into consideration the amount of the sensors 14. Specifically, the sensor 1, the sensor 2 and the sensor 3 are disposed at the first joint 13A, the sensor 4, the sensor 5 and the sensor 6 are disposed at the second joint 13B, the sensor 7, the sensor 8 and the sensor 9 are disposed at the third joint 13C, and the sensor 10, the sensor 11 and the sensor 12 are disposed at the fourth joint 13D. FIG. 1E shows a cross-sectional view scale drawing along a section line 1B-1B′ of FIG. 1A according to another embodiment of the present disclosure. A ring sensor 14 is disposed at each joint 13A, 13B, 13C or 13D.

In the embodiment, the sensors 14 may be fixed (e.g., adhered) on a surface 1111 of the second stopper 111, which faces the first stopper 121. As exemplified in FIG. 1B, three sensors 14 are equally spaced on the surface 1111 of the second stopper 111. The flange 121A of first stopper 121 of the embodiment may face the surface 1111 of the second stopper 111, and may have bumps 1212 respectively facing the sensors 14. In the embodiment, a plurality of (e.g., three) elastic members 15 (e.g., sponge or spring) may be disposed between the first stopper 121 and the second stopper 111 for restoring the first movable member 11A or the second movable member 11B to an initial position, that is, a position before pressing the sensors 14. FIG. 1F shows a top-view scale drawing of the second stopper 111. The elastic members 15 may be fixed (e.g., adhered) on the surface 1111 of the second stopper 111, and be disposed between the sensors 14, respectively. It is appreciated that the positions and the amount of the sensors 14, the bumps 1212 and the elastic members 15 are not limited to the shown embodiment. For example, in another embodiment (not shown), the sensors 14 may be fixed on the surface 1211 of the flange 121A of the first stopper 121, and the bumps 1212 may be disposed on the surface 1111 of the second stopper 111 and face the sensors 14. The elastic members 15 may be disposed on the surface 1211 of the flange 121A of the first stopper 121, and be disposed between the sensors 14, respectively.

When a user holds the first movable member 11A and the second movable member 11B by the right hand and the left hand respectively with intent toward a specific direction, the sensors 14 at the joints 13A, 13B, 13C and 13D may detect different sense values. A sequence composed of elements respectively representing the sense values of the sensor 1 to the sensor 12 may, for example, be [3010, 2511, 2133, 3, 15, 2, 3201, 2004, 3121, 1, 5, 7] with intent toward front; may be [4012, 3400, 2311, 2, 4, 10, 3, 2, 7, 1291, 1311, 1412] with intent toward font left; and may be [1, 2, 11, 1302, 1231, 1212, 2311, 3211, 4033, 21, 12, 15] with intent toward front right. FIG. 1G shows a table illustrating the sense values of the sensor 1 to the sensor 12 with a variety of intent toward various directions. The sense values compared relatively are roughly classified into large, middle and small.

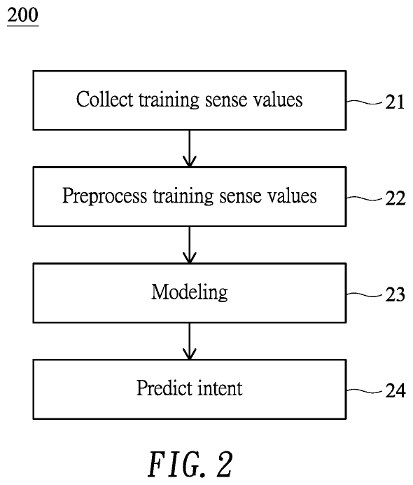

FIG. 2 shows a flow diagram illustrating a method 200 of determining intent on moving direction adaptable to the walker 10 according to one embodiment of the present disclosure. In step 21, while the first movable member 11A and the second movable member 11B are held by the right hand and the left hand respectively with intent toward a specific direction, (training) sense values of the sensors 14 may be collected as training data. In addition, (testing) sense values may be collected as testing data. In the embodiment, six moving directions (i.e., front, front left, front right, rear, rear left and rear right) are performed and sense values of the sensors 14 are correspondingly collected. Moreover, sense values of the sensors 14 are correspondingly collected when the walker 10 stops. The collected sense values maybe stored in a database. The amount of moving directions may not be limited to six as exemplified above, but may be set according to specific applications.

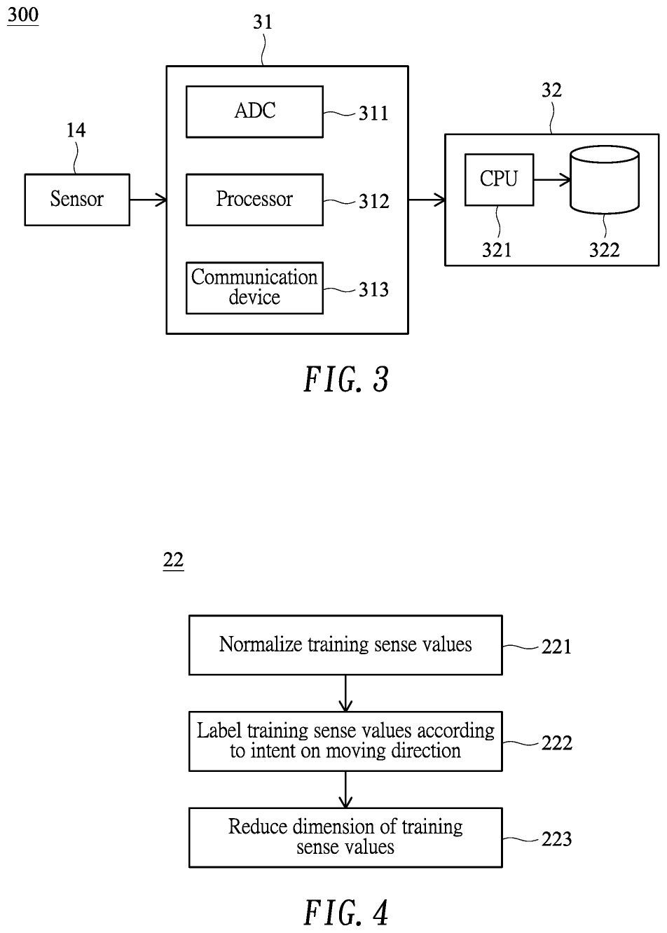

FIG. 3 shows a block diagram illustrating a system 300 of determining intent on moving direction according to one embodiment of the present disclosure. In the embodiment, the system 300 may include an agent 31 configured to collect sense values of the sensors 14. The agent 31 may commonly be disposed near the handle 100 of the walker 10. The agent 31 may include an analog-to-digital converter (ADC) 311 configured to convert the sense values from analog form into digital form. The agent 31 may include a processor (e.g., microprocessor) 312 configured to execute agent software to collect the digital-form sense values. The agent 31 may include a communication device 313, such as universal asynchronous receiver-transmitter (UART), configured to transfer the collected sense values to a computer 32. The computer 32 may commonly be disposed far away from the handle 100 of the walker 10, for example, at a bottom of the walker 10. The computer 32 may include at least a central processing unit (CPU) 321 and a database 322. The CPU 321 may process and transform the collected sense values into data files with specific format, which are then stored in the database 322.

Referring back to FIG. 2, in step 22, the sense values stored in the database 322 are preprocessed. FIG. 4 shows a detailed flow diagram of step 22 of FIG. 2, sequence of the steps of which is not limited to that shown in FIG. 2. In sub-step 221, the (training) sense values are normalized according to mean and standard deviation of the sense values, in order to reduce noise. In sub-step 222, the (training) sense values are correspondingly labeled according to intent on moving direction. In the embodiment, the (training) sense values are labeled as 0, 1, 2, 3, 4, 5 and 6 according to moving directions—front, front left, front right, rear, rear left, rear right and stop. Step 22 may also include sub-step 223, in which a dimension of the sense values may be reduced by using dimension reducing technique to facilitate observing and following processing. In the embodiment, T-distributed stochastic neighbor embedding (t-SNE) algorithm and principle component analysis (PCA) algorithm may, but not exclusively, be adopted to reduce the dimension of the sense values.

Referring back to the method 200 of FIG. 2, in step 23, machine-learning modeling is performed on the preprocessed sense values to obtain a machine-learning model. In one embodiment, support vector machines (SVMs) algorithm may be adopted to perform machine learning. As SVMs algorithm requires a substantive amount of computation, it is not suitable for real-time applications. In the embodiment, logistic modeling algorithm requires less amount of computation than SVMs algorithm, and thus is suitable for real-time applications.

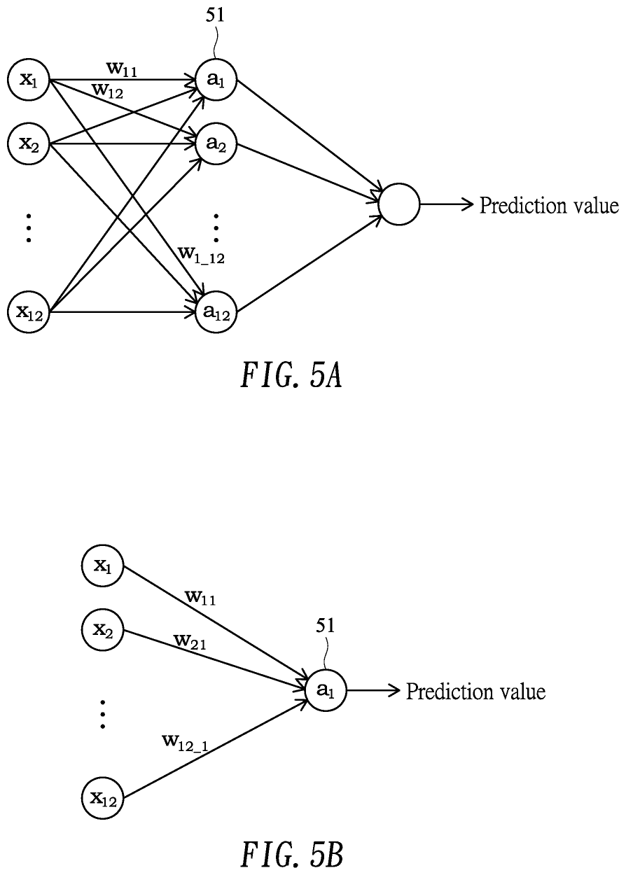

FIG. 5A schematically shows architecture of processing sense values to perform machine learning by using logistic modeling algorithm, where x₁, x₂ . . . x₁₂ respectively represent the sense values of the sensor 1, the sensor 2 . . . the sensor 12, a₁, a₂ . . . a₁₂ respectively represent logistic units 51, and w₁₁, w₁₂ . . . w_{1_12} respectively represent corresponding weights. FIG. 5B shows one logistic unit 51 of FIG. 5A, where w₁₁, w₂₁ . . . w_{12_1} respectively represent corresponding weights. FIG. 5A and FIG. 5B show the architecture of one artificial neural network, in which the logistic unit 51 is used as a neuron in the artificial neural network to perform logistic regression. According to the architecture, a linear combination of sense values xₙ and weights wₙ may be obtained such as x₁w₁₁+x₂w₂₁+ . . . +x₁₂w_{12_1}. Next, a value of the linear combination is applied to the logistic unit 51, which may include an activate function (e.g., sigmoid function), to determine whether the logistic function is activated. Accordingly, the weights wₙ may be obtained as the machine-learning model by applying the (training) sense values to the architecture of FIG. 5A and FIG. 5B. Moreover, after obtaining the machine-learning model (i.e., weights), the (testing) sense values may be applied to the model to verify whether the model is correct.

Referring back to the method 200 of FIG. 2, in step 24, intent on moving direction may be outputted according to the (measured) sense values of the sensors 14 of the handle 100 of the walker 10 based on the machine-learning model (step 23). The intent on moving direction may be used later to control other components (e.g., servo brake or motor) of the walker 10.

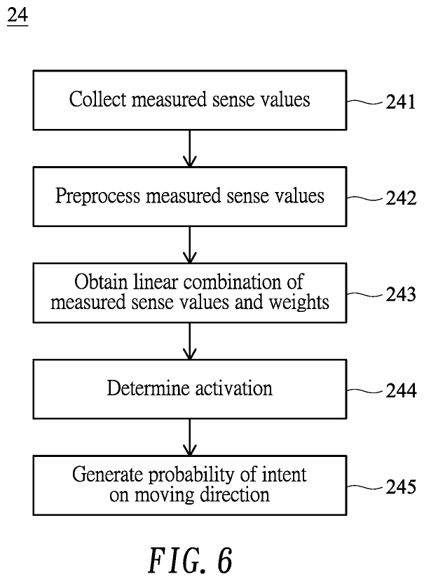

FIG. 6 shows a detailed flow diagram of step 24 of FIG. 2. In sub-step 241, while the first movable member 11A and the second movable member 11B are held by the right hand and the left hand respectively with intent toward a specific direction, (measured) sense values of the sensors 14 may be collected as measured data. Step 241 is similar to step 21 of FIG. 2, details of which are omitted for brevity.

Next, in sub-step 242, the (measured) sense values are preprocessed. Similar to step 221 of FIG. 4, the (measured) sense values are normalized in according to mean and standard deviation of the (measured) sense values, in order to reduce noise.

In sub-step 243, a linear combination of the (measured) sense values and the weights are calculated, as shown in FIG. 5A and FIG. 5B, based on the model (i.e., weights) obtained in step 23. Next, in sub-step 244, a value of the linear combination may be applied to the logistic unit 51, which may include the activate function (e.g., sigmoid function) to determine whether the logistic unit 51 is activated.

In sub-step 245, a probability (as a prediction) of the intent on moving direction may be generated according to a result of the logistic unit 51, according to which the intent on moving direction corresponding to the measured sense values may be determined. In one embodiment, one-vs-rest (OVR) technique may be adopted to generate the probability of the intent on moving direction. In another embodiment, multinomial technique may be adopted to generate the probability of the intent on moving direction. In sub-step 245, L2 (or L₂ or weight decay) regularization technique may also be adopted to prevent overfitting issue in order to enhance prediction accuracy.

Although specific embodiments have been illustrated and described, it will be appreciated by those skilled in the art that various modifications may be made without departing from the scope of the present disclosure, which is intended to be limited solely by the appended claims.

What is claimed is:

1. A handle of a walker capable of determining use intent, comprising:
at least one movable member;
a plurality of fixed members slidingly coupled to the at least one movable member respectively; and
a plurality of pressure sensors disposed at joints between the fixed members and the at least one movable member respectively.

2. The handle of claim 1, wherein the pressure sensor comprises a single-axis force sensor.

3. The handle of claim 1, wherein the at least one movable member comprises a first movable member and a second movable member.

4. The handle of claim 3, wherein two ends of the first movable member are slidingly coupled to the fixed members at a first joint and a second joint respectively, two ends of the second movable member are slidingly coupled to the fixed members at a third joint and a fourth joint respectively, and at least one said pressure sensor is disposed at each of the first joint, the second joint, the third joint and the fourth joint.

5. The handle of claim 1, further comprising:
a first stopper disposed on and extended from a surface of the fixed member at said joint where the fixed member and the movable member are coupled to each other; and
a second stopper facing the first stopper, the second stopper extended from a surface of the movable member at said joint where the fixed member and the movable member are coupled to each other.

6. The handle of claim 5, wherein the pressure sensor is fixed on a surface of the second stopper or the first stopper.

7. The handle of claim 5, wherein a surface of the first stopper or the second stopper has at least one bump facing the corresponding pressure sensor.

8. The handle of claim 5, further comprising a plurality of elastic members disposed between the first stopper and the second stopper.

9. A method of operating a walker capable of determining use intent, the method comprising:
collecting training sense values of a plurality of pressure sensors of a handle of the walker according to moving directions of the handle;
preprocessing the training sense values;
performing machine-learning modeling on the preprocessed training sense values to obtain a machine-learning model; and
predicting intent on moving direction according to measured sense values of the pressure sensors of the handle based on the machine-learning model.

10. The method of claim 9, wherein the pressure sensor comprises a single-axis force sensor.

11. The method of claim 9, further comprising:
collecting testing sense values of the plurality of pressure sensors according to moving directions of the handle.

12. The method of claim 9, wherein the step of preprocessing the training sense values comprises:
normalizing the training sense values according to mean and standard deviation of the training sense values.

13. The method of claim 9, wherein the step of preprocessing the training sense values comprises:
correspondingly labeling the training sense values according to moving directions of the handle.

14. The method of claim 9, wherein the step of preprocessing the training sense values comprises:
reducing a dimension of the training sense values by using dimension reducing technique.

15. The method of claim 9, wherein the step of machine-learning modeling comprises:
performing machine learning by using logistic modeling algorithm.

16. The method of claim 9, wherein the machine-earning model comprises:
at least one logistic unit used as a neuron in an artificial neural network, the logistic unit including an activate function that outputs a linear combination of the training sense values and weights.

17. A method of operating a walker capable of determining use intent, the method comprising:
providing a machine-learning model that is obtained by performing machine-learning modeling on training sense values collected from a plurality of pressure sensors of a handle of the walker; and
predicting intent on moving direction according to measured sense values of the pressure sensors of the handle based on the machine-learning model.

18. The method of claim 17, wherein the pressure sensor comprises a single-axis force sensor.

19. The method of claim 17, wherein the step of predicting the intent on moving comprises:
normalizing the measured sense values according to mean and standard deviation of the measured sense values.

20. The method of claim 17, wherein the machine-earning model comprises:
at least one logistic unit used as a neuron in an artificial neural network, the logistic unit including an activate function that outputs a linear combination of the measured sense values and weights.

21. The method of claim 20, wherein the step of predicting the intent on moving direction comprises:
obtaining the linear combination of the measured sense values and the weights;
applying a value of the linear combination to the logistic unit to determine whether the logistic unit is activated; and
generating a probability of the intent on moving direction according to a result of the logistic unit.

22. The method of claim 21, wherein the step of generating the probability comprises:
generating the probability of the intent on moving direction by using one-vs-rest (OVR) technique.

23. The method of claim 21, wherein the step of generating the probability comprises:
generating the probability of the intent on moving direction by using multinomial technique.

24. The method of claim 21, wherein the step of generating the probability comprises:
adopting L2 regularization technique to prevent overfitting issue.
